(19) United States
(12) Patent Application Publication
(10) Pub. No.: US 2019/0039445 A1
(43) Pub. Date: Feb. 7, 2019

(54) Vehicle Protection Assembly

(71) Applicant: Felix Agbebaku, Plano, TX (US)

(72) Inventor: Felix Agbebaku, Plano, TX (US)

(21) Appl. No.: 15/667,936

(22) Filed: Aug. 3, 2017

(51) Int. Cl. B60J 11/04

(52) U.S. Cl. CPC B60J 11/04

(57) ABSTRACT

A vehicle protection assembly for protecting a vehicle from hail damage includes a plurality of pads. The plurality of pads is movably connected together into a plurality of columns and rows. Moreover, the plurality of pads is selectively positioned to cover a top side of a vehicle. Each of the pads is comprised of a resiliently compressible to absorb impact energy from hail thereby inhibiting the hail from damaging the vehicle. A plurality of straps is provided and each of the straps is coupled to the plurality of pads. A plurality hooks is provided and each of the hooks is coupled to an associated one of the straps. Each of the hooks engages the vehicle thereby retaining the plurality of pads on the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to protection devices and more particularly pertains to a new protection device for protecting a vehicle from hail damage.

### BRIEF SUMMARY OF THE INVENTION

An embodiment of the disclosure meets the needs presented above by generally comprising a plurality of pads. The plurality of pads is movably connected together into a plurality of columns and rows. Moreover, the plurality of pads is selectively positioned to cover a top side of a vehicle. Each of the pads is comprised of a resiliently compressible to absorb impact energy from hail thereby inhibiting the hail from damaging the vehicle. A plurality of straps is provided and each of the straps is coupled to the plurality of pads. A plurality hooks is provided and each of the hooks is coupled to an associated one of the straps. Each of the hooks engages the vehicle thereby retaining the plurality of pads on the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a vehicle protection assembly according to an embodiment of the disclosure.

FIG. 2 is a front view of an embodiment of the disclosure.

FIG. 3 is a perspective cut-away view taken from circle 3 of FIG. 2 of an embodiment of the disclosure.

FIG. 4 is a side perspective in-use view of an embodiment of the disclosure.

FIG. 5 is a front perspective in-use view of an embodiment of the disclosure.

FIG. 6 is a top perspective view of an embodiment of the disclosure.

### DETAILED DESCRIPTION OF THE INVENTION

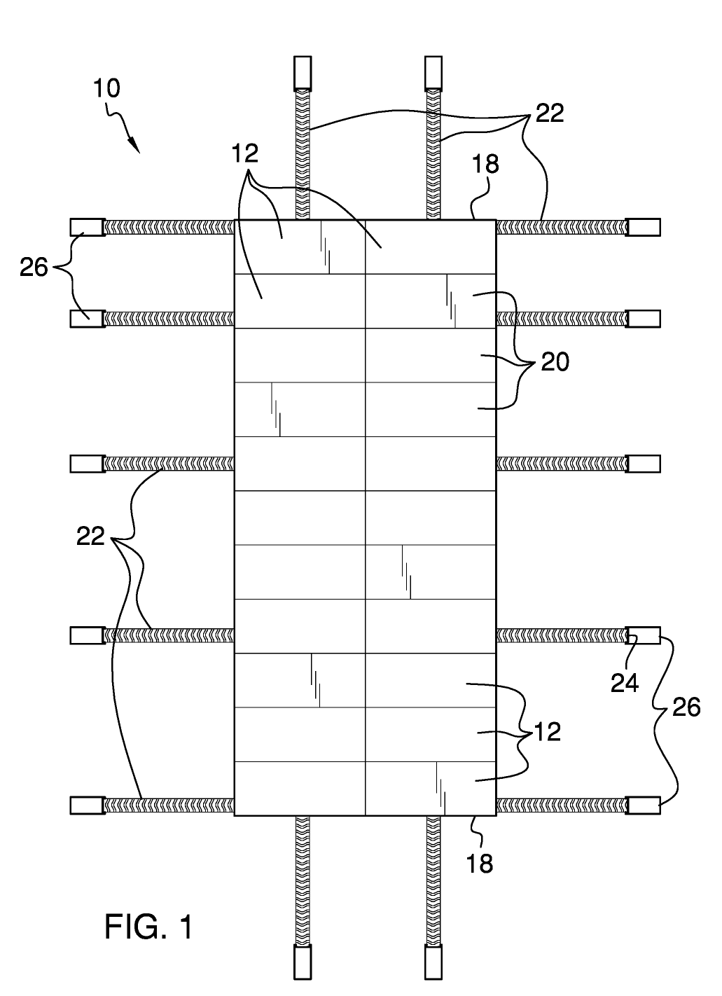

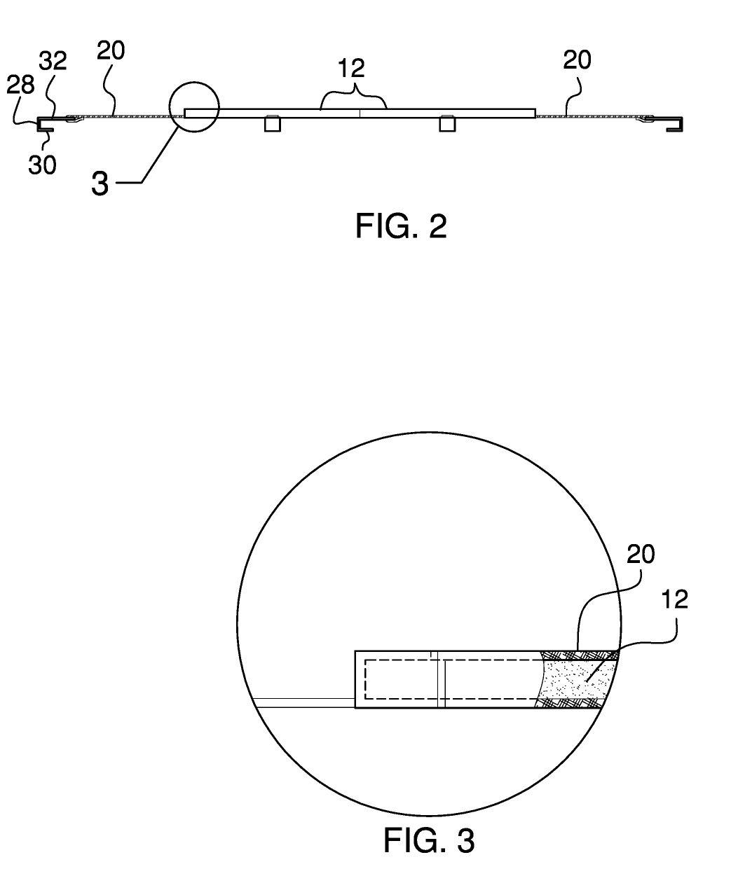

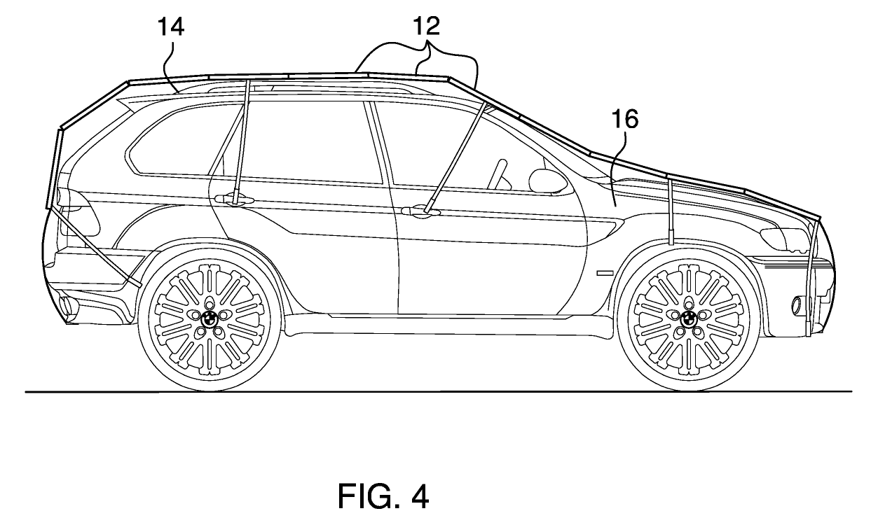

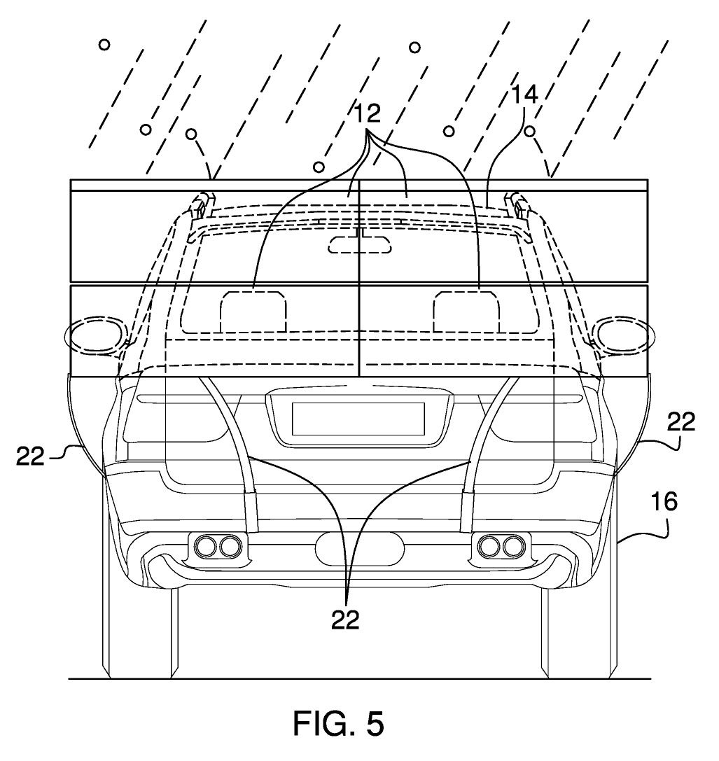

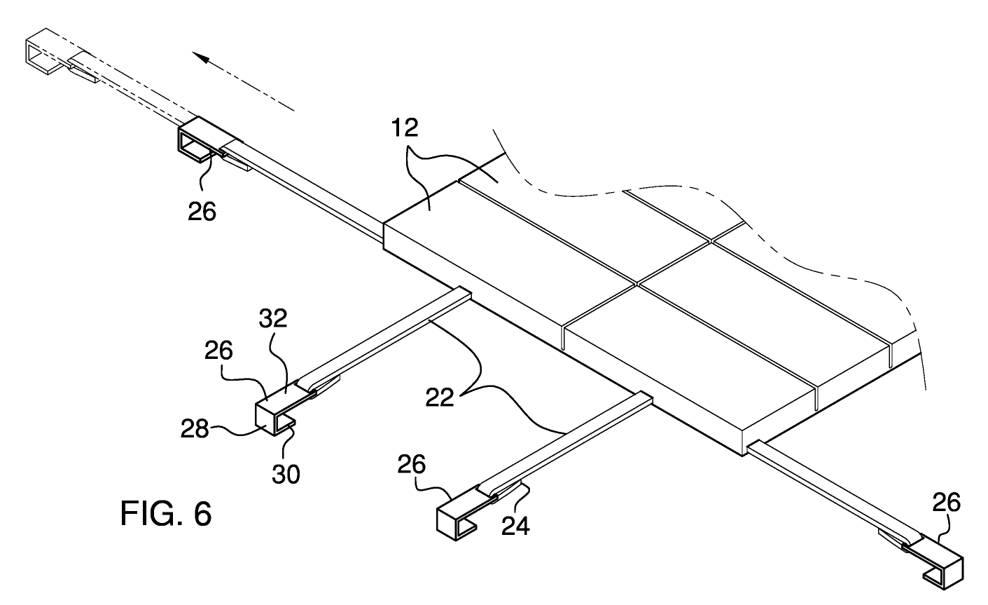

With reference now to the drawings, and in particular to FIGS. 1 through 6 thereof, a new protection device embodying the principles and concepts of an embodiment of the disclosure and generally designated by the reference numeral 10 will be described.

As best illustrated in FIGS. 1 through 6, the vehicle protection assembly 10 generally comprises a plurality of pads 12. The pads 12 are movably connected together into a plurality of columns and rows. The plurality of pads 12 is selectively positioned to cover a top side 14 of a vehicle 16. The vehicle 16 may be a passenger car and any other vehicle 16 that has deformable body panels. Each of the pads 12 is comprised of a resiliently compressible material such as foam rubber or the like. Thus, each of the pads 12 absorbs impact energy from hail thereby inhibiting the hail from damaging the vehicle 16 and each of the pads 12 has a perimeter edge 18.

A plurality of bags 20 is provided and each of the pads 12 is positioned within an associated one of the bags 20. Moreover, each of the bags 20 is enclosed around each of the pads 12 such that each of the pads 12 is inhibited from being removed from the associated bag 20. The plurality of bags 20 may be coupled together to form the plurality of columns and rows. Each of the bags 20 is comprised of a deformable material to inhibit the pads 12 from scratching the vehicle 16. Additionally, each of the bags 20 may be defined by an outer surface of the pads 12 that is comprised of the deformable material, such as cotton or the like.

A plurality of straps 22 is provided and each of the straps 22 is coupled to the plurality of pads 12. Each of the straps 22 has a distal end 24 with respect to the pads 12. The plurality of straps 22 is positioned on the perimeter edge 18 of a corresponding one of the pads 12 and the straps 22 is spaced apart from each other. Each of the straps 22 is comprised of an elastic material.

A plurality hooks 26 is provided and each of the hooks 26 is coupled to an associated one of the straps 22. Each of the hooks 26 engages the vehicle 16 thereby retaining the plurality of pads 12 on the vehicle 16. Each of the hooks 26 has a leg 28, a foot 30 and a body 32. The leg 28 extends away from the body 32 and the foot 30 is spaced from the body 32. The body 32 is coupled to the distal end 24 of an associated one of the straps 22. Thus, the leg 28 and the foot 30 on each of the hooks 26 engage the vehicle 16 at a selected point on the vehicle 16.

In use, the plurality of pads 12 is positioned to cover the vehicle 16 when hail is impending and expected. The hook 26 on each of the straps 22 is manipulated to engage the vehicle 16. In this way the straps 22 inhibits the pads 12 from being removed from the vehicle 16 by wind or the like. Each of the pads 12 absorbs impact energy from the hail thereby inhibiting the hail from denting the vehicle 16. Each of the hooks 26 and the pads 12 are removed from the vehicle 16 thereby facilitating the vehicle 16 to be driven.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle protection assembly being configured to protect a vehicle from hail damage, said assembly comprising:
a plurality of pads, said plurality of pads being movably connected together into a pair of columns and plurality of rows, each of said pads being substantially planar wherein said plurality of pads is configured to be positioned to cover a top side of a vehicle such that a free edge of each of said pair of columns of said plurality of pads extends laterally outward over and beyond a respective lateral surface of the vehicle, each of said pads being comprised of a resiliently compressible material wherein each of said pads is configured to absorb impact energy from hail thereby inhibiting the hail from damaging the vehicle;
a plurality of straps each of said straps being coupled to said plurality of pads; and
a plurality hooks, each of said hooks being coupled to an associated one of said straps wherein each of said hooks is configured to engage the vehicle thereby retaining said plurality of pads on the vehicle.

2. The assembly according to claim 1, further comprising a plurality of bags, each of said pads being positioned within an associated one of said bags, each of said bags being comprised of a deformable material wherein each of said bags is configured to inhibit said pads from scratching the vehicle.

3. The assembly according to claim 1, wherein each of said straps has a distal end with respect to said pads, said plurality of straps being positioned on a perimeter edge of a corresponding one of said pads, said straps being spaced apart from each other, each of said straps being comprised of an elastic material.

4. The assembly according to claim 3, wherein each of said hooks has a leg, a foot and a body, said leg extending away from said body having said foot being spaced from said body, said body being coupled to said distal end of an associated one of said straps wherein said leg and said foot on each of said hooks is configured to the vehicle.

5. A vehicle protection assembly being configured to protect a vehicle from hail damage, said assembly comprising:
a plurality of pads, said plurality of pads being movably connected together into a pair of columns and a plurality of rows, each of said pads being substantially planar wherein said plurality of pads is configured to be positioned to cover a top side of a vehicle such that a free edge of each of said pair of columns of said plurality of pads extends laterally outward over and beyond a respective lateral surface of the vehicle, each of said pads being comprised of a resiliently compressible material wherein each of said pads is configured to absorb impact energy from hail thereby inhibiting the hail from damaging the vehicle, each of said pads having a perimeter edge;
a plurality of bags, each of said pads being positioned within an associated one of said bags, each of said bags being comprised of a deformable material wherein each of said bags is configured to inhibit said pads from scratching the vehicle;
a plurality of straps each of said straps being coupled to said plurality of pads, each of said straps having a distal end with respect to said pads, said plurality of straps being positioned on said perimeter edge of a corresponding one of said pads, said straps being spaced apart from each other, each of said straps being comprised of an elastic material; and
a plurality hooks, each of said hooks being coupled to an associated one of said straps wherein each of said hooks is configured to engage the vehicle thereby retaining said plurality of pads on the vehicle, each of said hooks having a leg, a foot and a body, said leg extending away from said body having said foot being spaced from said body, said body being coupled to said distal end of an associated one of said straps wherein said leg and said foot on each of said hooks is configured to engage the vehicle.
